(19) United States
(12) Patent Application Publication
(10) Pub. No.: US 2024/0338625 A1
(43) Pub. Date: Oct. 10, 2024

(54) SYSTEM AND METHOD TO GENERATE SCHEDULE FOR PRODUCT RELEASE

(71) Applicants: Mark R. Melanson, West Hartford, CT (US); Despina Bartos, Tampa, FL (US); Inna M. Zhitomirsky, West Hartford, CT (US); Alan S. Mickey, Coventry, CT (US); Luis Sergio Marques, Glastonbury, CT (US)

(72) Inventors: Mark R. Melanson, West Hartford, CT (US); Despina Bartos, Tampa, FL (US); Inna M. Zhitomirsky, West Hartford, CT (US); Alan S. Mickey, Coventry, CT (US); Luis Sergio Marques, Glastonbury, CT (US)

(21) Appl. No.: 18/297,065

(22) Filed: Apr. 7, 2023

(51) Int. Cl. G06Q 10/0631; G06Q 30/0283; G06Q 50/18

(52) U.S. Cl. CPC G06Q 10/06316; G06Q 30/0283; G06Q 50/18

(57) ABSTRACT

According to some embodiments, systems and methods are provided including instructions to: receive a request to generate a schedule for execution of a workflow associated with at least one product; retrieve one or more workflow parameters and one or more location parameters; input the retrieved one or more workflow parameters and one or more location parameters into a scheduler; automatically generate a workflow schedule via the scheduler based on the retrieved one or more workflow parameters and location parameters; import the generated workflow schedule to a project plan. Numerous other aspects are provided.

### TECHNICAL FIELD

The present application generally relates to computer systems and more particularly to computer systems that are adapted to accurately, securely, and/or automatically manage a workflow for a product release.

### BACKGROUND

Organizations make use of workflows to provide a visualization of a flow of data in executing a series of tasks, with the goal of executing an organizational process. A given workflow may be complex and include multiple tasks. The workflow may include a sequence of process steps or operations that may be manually supported and/or may be supported by one or more automation tools (i.e., software tools) used by the organization. In some instances, the process steps may be chained together to complete the organizational process, whereby data created during execution of one of the process steps may be used by a next processing step. As a non-exhaustive example, a first process step may define requirements for a given product, and then those defined requirements may be received by a second process step that determines a first milestone date based on the defined requirements. Then that first milestone date may be used by a third process to generate a date for submission of a report, etc. The defined requirements for the given product may vary based on an entity associated with the product. As another non-exhaustive example, in a case the entity is a region, requirements for the product in West Virginia may be different from requirements for the product in Michigan. While the process steps (define requirements, determine first milestone date, and generate report submission date) of the workflow may be the same irrespective of the entities associated with the product, the requirements associated with the entities may make the actual dates for the process steps different. Continuing with the above example, the workflow may have a same delivery date for a product in West Virginia and in Michigan, however, because of different requirements, the second process step (milestone) may be reached in West Virginia before Michigan, which then may affect the third process step of generating the report submission date. It may be challenging for an organization to implement the organizational process in view of the different requirements.

It would be desirable to provide improved systems and methods to accurately and/or automatically provide a schedule for a workflow. Moreover, the schedule should be easy to access, understand, interpret, update, etc.

### SUMMARY OF THE INVENTION

According to some embodiments, systems, methods, apparatus, computer program code and means are provided to generate a schedule for executing tasks of a workflow.

Some embodiments are directed to a system implemented via a back-end application computer server. The system may include a workflow datastore, one or more products, a back-end application computer store and a communication port. The workflow data store may contain a plurality of workflows, with each workflow including a plurality of executable tasks. The back-end application computer serve is coupled to the workflow data store. The back-end application computer server includes a computer processor and a computer memory. The computer memory is coupled to the computer processor and stores instructions that, when executed by the computer processor, cause the back-end application computer server to: receive a request to generate a schedule for execution of a workflow associated with a first product; retrieve one or more workflow parameters and one or more location parameters; input the retrieved one or more workflow parameters into a scheduler; automatically generate a workflow schedule via the scheduler based on the retrieved one or more workflow parameters and location parameters; and import the generated workflow schedule to a project plan. The system also includes a communication port coupled to the back-end application computer server. The communication port facilitates the exchange of data with a remote device to support interactive user interface displays that provide information about the schedule. The information may be exchanged, for example, via public and/or proprietary communication networks.

Some embodiments comprise: a method implemented via a back-end application computer server of an enterprise. The method comprises receiving a request to generate a schedule for execution of a workflow associated with at least one product; retrieving one or more workflow parameters and one or more location parameters; inputting the retrieved one or more workflow parameters and one or more location parameters into a scheduler; automatically generating a workflow schedule via the scheduler based on the retrieved one or more workflow parameters one or more location parameters, wherein the workflow schedule includes a date of execution for each task; and importing the generated workflow schedule to a project plan.

Other embodiments comprise: a non-transitory, computer-readable medium storing instructions that, when executed by a processor, cause the processor to perform a method implemented via a back-end application computer server of an enterprise. The method comprises receiving a request to generate a schedule for execution of a workflow associated with at least one product; retrieving one or more workflow parameters and one or more location parameters; inputting the retrieved one or more workflow parameters and the one or more location parameters into a scheduler; automatically generating a workflow schedule via the scheduler based on the retrieved one or more workflow parameters and one or more location parameters, wherein the workflow schedule includes a date of execution for each task; and importing the generated workflow schedule to a project plan.

A technical effect of some embodiments of the invention is the improved and computerized product release workflow scheduler for an organization that provides fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 shows a workflow according to some embodiments.

FIG. 2 is a block diagram of a system architecture according to some embodiments.

FIG. 3 is a flow diagram according to some embodiments.

FIG. 4 is an outward view of a graphical user interface according to some embodiments.

FIG. 5A is an outward view of a schedule on a graphical user interface according to some embodiments.

FIG. 5B is an outward view of the schedule of FIG. 5A on a different graphical user interface according to some embodiments.

FIG. 6A is an outward view of another schedule on a graphical user interface according to some embodiments.

FIG. 6B is an outward view of an update to the schedule of FIG. 7A on a graphical user interface according to some embodiments.

FIG. 7 is an outward view of yet another schedule on a graphical user interface according to some embodiments.

FIG. 8 is an outward view of still another schedule on a graphical user interface according to some embodiments.

FIG. 9 is a flow diagram according to some embodiments.

FIG. 10 is a flow diagram according to some embodiments.

FIG. 11 is an outward view of another schedule on a graphical user interface according to some embodiments.

FIG. 12 is a block diagram of a system according to some embodiments.

FIG. 13 is a block diagram of a system according to some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

The following description is provided to enable any person in the art to make and use the described embodiments and sets forth the best mode contemplated for carrying out some embodiments. Various modifications, however, will remain readily apparent to those in the art.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

The present invention provides significant technical improvements to facilitate data processing associated with streamlining the scheduling of the release of a product across multiple regions. The present invention is directed to more than merely a computer implementation of a routine or conventional activity previously known in the industry as it provides a specific advancement in the area of electronic record analysis by providing improvements in the operation of a computer system that customizes a schedule for tasks that make up a workflow related to releasing a software product (including those associated with risk relationships). The present invention provides improvement beyond a mere generic computer implementation as it involves the novel ordered combination of system elements and processes to provide improvements in the speed, security, and accuracy of such a scheduling tool for an enterprise. Some embodiments of the present invention are directed to a system adapted to automatically customize and execute scheduling of a workflow, identify the availability of resources to execute the workflow, aggregate data from multiple data sources, automatically optimize equipment information to reduce unnecessary messages or communications, etc. (e.g., to consolidate task data). Moreover, communication links and messages may be automatically established, aggregated, formatted, modified, removed, exchanged, etc. to improve network performance (e.g., by reducing an amount of network messaging bandwidth and/or storage required to create workflow messages or alerts, improve security, reduce the size of a workflow data store, more efficiently collect data, etc.).

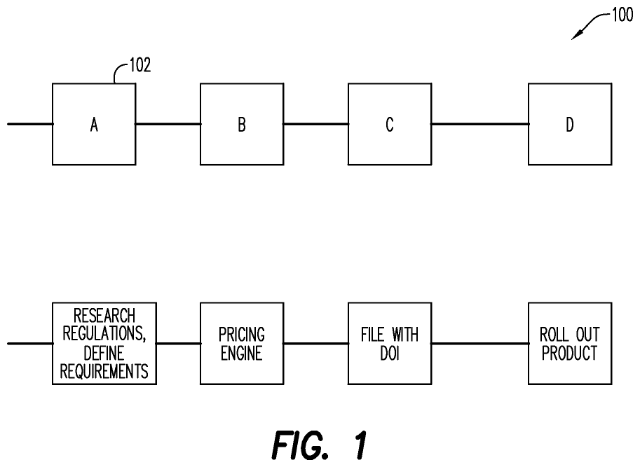

FIG. 1 shows a workflow 100 according to some embodiments. In particular, an organization, such as an insurance company, may have a risk relationship product(s) (e.g., insurance policies for home and/or automobile) that they would like to make available (e.g., release) to parties (either directly with the parties or through entities such as employers). The product may be a new product, an update of a product (e.g., modifying an existing feature), or an extension (e.g., adding a feature) of the product. The organization may have one or more particular tasks 102 (e.g., A-D) that may be executed to prepare the product for release. Together the sequence of tasks may be part of a workflow 100, such that the workflow 100 comprises and is defined by a series of steps/tasks 102 that are completed to obtain/complete an objective (e.g., releasing/rolling out the product). As a non-exhaustive example, the tasks may include researching the product and/or regulations (e.g., state regulations) associated with rolling out the product and defining requirements (e.g., what does the plan cover) for the product based on those regulations (task “A”), execution of a pricing engine to define a price for the product (e.g., the price may vary based on the product and different regulations etc.) (task “B”), filing a product plan with a regulatory agency (e.g., Department of Insurance “DOI”) (task “C”), releasing the product (task “D”). The product plan may include the product rates and rules, and may need to be filed for each state.

Workflow rules may include, but are not limited to, rules that define the workflow having the sequence of tasks, the date the tasks must be completed by, the resource that will perform the tasks, and the length of time that resource takes to complete the task. Workflow rules may restrict how tasks are scheduled. For example, task A must be completed by a particular time and will take a pre-defined number of hours to complete. The workflow rules may be data objects stored in a database.

According to some embodiments, the product may be made available to parties in different locations (e.g., regions or states). Each location may have different procedures and requirements (“location rules”) for a product to meet before the product may be available for parties in that respective region or state. These procedures and requirements may be stored in a location datastore 216. For example, the DOI for Iowa may have a “file and use 30 day” policy whereby the product may be released after filing the product plan with the DOI (or appropriate regulator) within a specified time period (in this case, 30 days), while West Virginia may have a 60 day prior approval policy whereby the product may be released 60 days after the product plan has been approved. As another example, the DOI for some states may require a particular task, while the DOI for other states do not require a particular task.

An organization may want to release the product in different states on a same date, for example. In view of the different location rules, the time period for executing each of the tasks in a workflow may vary. As the number, interrelation, and sequence of tasks become more complex, the importance, and difficulty of tracking, organizing, scheduling and evaluating workflows increases. Conventionally, it may be challenging for an organization to schedule the rollout of a product across 50 states. Conventionally, it may also be challenging for an organization to have a suitable amount of resources to accommodate the execution of a particular task at a particular time.

As described above, the workflow 100 comprises and is defined by a series of steps/tasks 102 that are completed to obtain/complete an objective (e.g., releasing/rolling out the product). In some instances, the workflow may have a level of repeatability, as the workflow may be repeated across multiple lines of business (e.g., home insurance and automobile insurance) across all fifty states. As further described above, the states may need to go through this workflow, but in their own time, as they may have different filing strategies that come from the different departments of insurance for each state. Additionally, a schedule may initially be set, and then other demands may cause the one or more schedules to be adjusted. For example, while a pricing task may span four months in length, this may need to be taken into account with respect to a release data and a filing strategy for a given location, since some organizations mandate a product's approval. These different constraints may also result in different locations being targeted for product release at different times. Embodiments provide for scheduling of workflows for different locations to be executed in parallel and simultaneously as the effective release date may be the same for different locations, but the tasks may be scheduled at different times.

Embodiments provide a product release scheduling management system (“scheduling tool”) to configure a schedule for different tasks in a workflow based on one or more parameters (e.g., workflow/location rules (e.g., requirements/regulations), pricing, resource availability, etc.). As used herein, a “schedule” may be the order and timing that the tasks will be performed. The schedule may be divided by days, hours, or other suitable categorization. The role of the schedule is to prioritize/order the tasks of the workflow according to a variety of criteria including, but not limited to, dependency between tasks, time requirements, and resource availability. A “resource” may be a machine/process/user necessary to complete a task or subtask. Using the parameters defined for different workflows and different locations, the scheduling tool may capture data received from one or more parties, set definitions and requirements, and generate a scheduled execution time for each task in the workflow. The tool may use historical data and a machine learning model/artificial intelligence to generate the scheduled execution time. For example, past task completion data and other data—obtained from sources like log files, timesheets, activity files and records of previously performed tasks and the time associated with performing these tasks—may be used to generate a schedule via a task scheduling algorithm. Feedback on how close the time for actual completion of the task is to the generated schedule may be added as historical data to a machine learning model to feed forward into new and future schedules.

Additionally, the scheduling tool may modify the generated execution time of different tasks based on modification to a task (e.g., a workflow with four tasks has a delay at task 2, and the generated scheduled execution time for tasks 3 and/or 4 may be re-generated/adjusted to account for the delay). In one or more embodiments, the generated schedule may be imported to a project plan and/or other suitable system. For example, the generated schedule may be received by a resource allocation system to determine whether appropriate resources are available to execute each task. In some embodiments, the resource allocation system may send feedback to the scheduling tool indicating enough resources are not available (which may be considered a task modification), and the scheduling tool may re-generate a schedule.

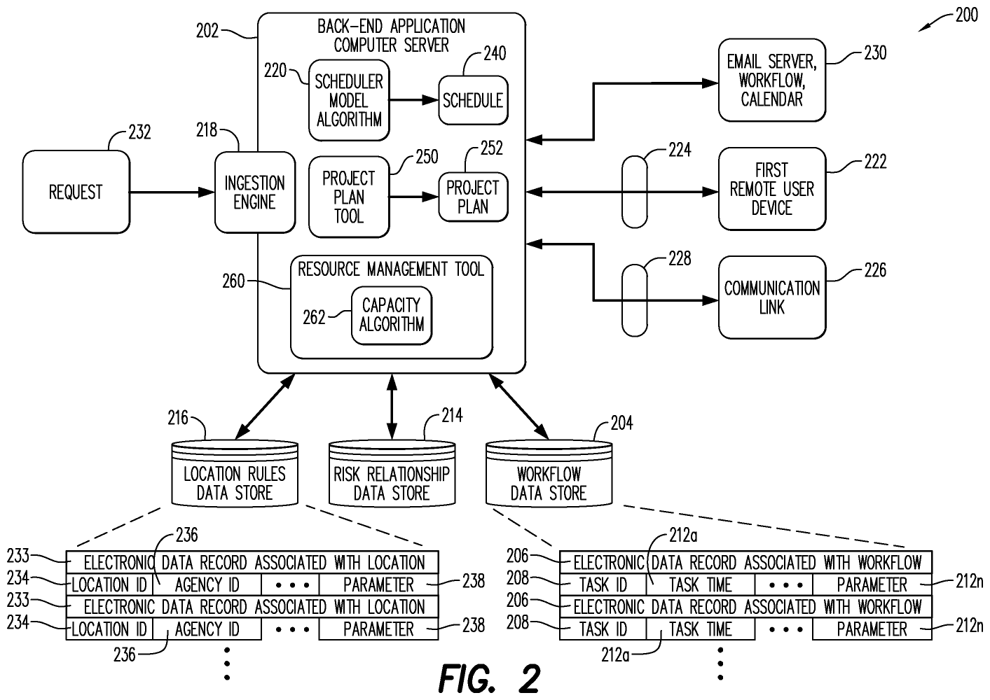

FIG. 2 is a high-level block diagram of a product release scheduling management system 200 that may be provided according to some embodiments of the present invention. In particular, the system 200 includes a back-end application computer server 202 that may access information in a workflow data store 204 (e.g., storing a set of electronic records associated with various workflows 206, each workflow record 206 including, for example, one or more task identifiers 208, amount of time each task takes (“task time” parameter 212a), other task parameters 212n including inputs for each task, outputs for each task, etc.). The task time parameter and other parameters may be non-exhaustive examples of the “workflow rules”. The back-end application computer server 202 may also store information into other data stores, such as a risk relationship data store 214, a location rules data store 216, and utilize an ingestion engine 218 and scheduler model algorithm 220 to exchange and process messages (e.g., daily/weekly data sweeps or on-demand changes) and view, analyze, and/or update the electronic records. The back-end application computer server 202 may also exchange information with a remote user device 222 (e.g., via a firewall 224). The back-end application computer server 202 may also exchange information via communication links 226 (e.g., via communication port 228 that may include a firewall) to communicate with different systems. The back-end application computer server 202 may also transmit information directly to an email server, workflow application, and/or calendar application 230 to facilitate automated communications and/or other actions. According to some embodiments, an interactive graphical user interface platform of the back-end application computer server 202 may facilitate resource management, schedule recommendations, alerts, and/or the display of results via one or more remote administrator computers (e.g., to display the schedule) and/or the remote user device 222. For example, the remote user device 222 may transmit annotated and/or updated information regarding a task delay to the back-end application computer server 202. Based on the updated information, the back-end application computer server 202 may adjust data in the workflow data store 204 and/or the location rules data store 216 and the change may (or may not) be used in connection with other systems. Note that the back-end application computer server 202 and/or any of the other devices and methods described herein might be associated with a third party, such as a vendor that performs a service for an organization.

The back-end application computer server 202 and/or the other elements of the system 200 may be, for example, associated with a Personal Computer (“PC”), laptop computer, smartphone, an organization server, a server farm, and/or a database or similar storage devices. According to some embodiments, an “automated” back-end application computer server 202 (and/or other elements of the system 200) may facilitate the automated access and/or update of electronic records in the data stores 204, 214, 216 and/or the management of resources. As used herein, the term “automated” may refer to, for example, actions that can be performed with little (or no) intervention by a human.

Devices, including those associated with the back-end application computer server 202 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 202 may store information into and/or retrieve information from the workflow data store 204, the location rules data store 216, and/or the risk relationship data store 214. The data stores 204, 214, 216 may be locally stored or reside remote from the back-end application computer server 202. As will be described further below, the workflow data store may be used by the back-end application computer server 202 in connection with an interactive user interface to access and update electronic records. Although a single back-end application computer server 202 is shown in FIG. 2, any number of such devices may be included. Moreover, various devices described herein might be combined according to embodiments of the present invention. For example, in some embodiments, the back-end application computer server 202 and workflow data store 204 may be co-located and/or may comprise a single apparatus.

The elements of the system 200 may work together to perform the various embodiments of the present invention. Note that the system 200 of FIG. 2 is provided only as an example, and embodiments may be associated with additional elements or components. According to some embodiments, the elements of the system 200 automatically transmit information associated with an interactive user interface display over a distributed communication network. User interfaces 400, 500, 550, 600, etc. may be presented on any type of display apparatus (e.g., desktop monitor, smartphone display, tablet display) provided by any type of client device (e.g., desktop system, smartphone, tablet computer). The application, which is executed to provide user interface 400, 500, 550, 600, etc., may comprise a Web Browser, a standalone application, or any other application. Embodiments are not limited to user interface 400, 500, 550, 600, etc.

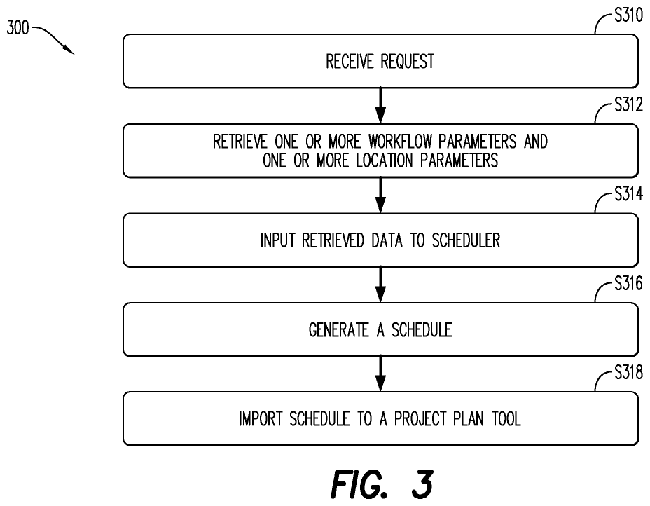

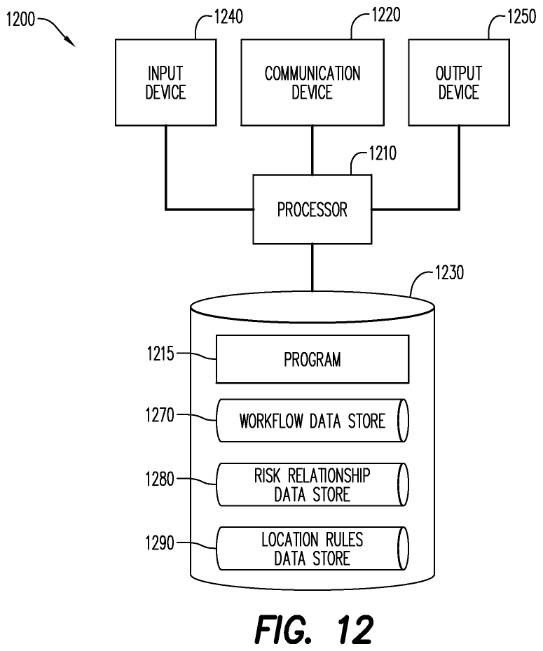

FIG. 3 illustrates a method 300 that might be performed by some or all of the elements of the system 200 described with respect to FIG. 2, or any other system, according to some embodiments of the present invention. In one or more embodiments, the back-end application computer server 202 may be conditioned to perform the process 300 and any other processes described herein, such that a processor 1210 (FIG. 12) of the server 202/system 200 is a special purpose element configured to perform operations not performable by a general-purpose computer or device. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein. The instructions may be embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

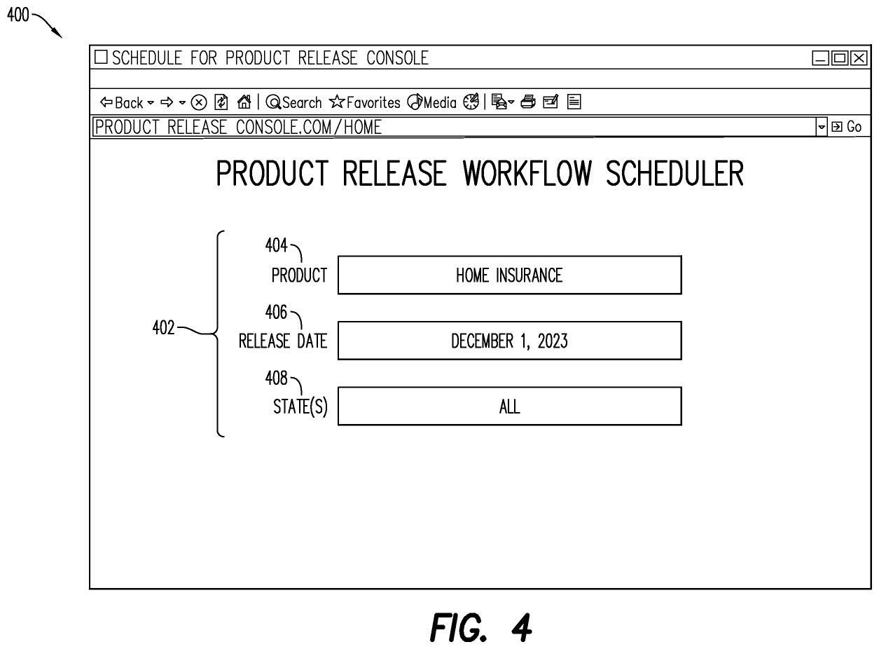

Initially at S310 a request to generate a schedule is received. The request 232 may be for execution of a workflow 100 associated with rolling out at least one product. The request 232 may be received via user-entry of values for one or more parameters 402 on a user interface 400 (FIG. 4). The parameters 402 may include, but are not limited to, the product 404, the release/effective date 406, and the location 408 where the release will occur. In the non-exhaustive example shown herein, the location refers to the states of the United States of America. The location may be linked to at least one filing strategy per a regulatory organization (e.g., need to file the product plan with X state six months before release). Other suitable parameters may be included.

Then in S312, one or more workflow parameters 212 and location parameters 238 (e.g., which may be non-exhaustive examples of “location rules” and/or regulations) are retrieved from their respective workflow data store 204 and location rule data store 216. The workflow parameters 212 may be an aggregation of the task parameters for the tasks included in the workflow. The workflow parameters 212 and location parameters 238 may include rules (and tasks in the case of the workflow parameters) as data objects stored in the database. The stored data includes, among other information, the tasks that make up the workflow, the sequence for completing those tasks, the resources needed to complete each task, time required to complete an associated task and a date the task must be completed. These constraints may be stored in a table and may be formed according to formulas or modeling results. Each constraint associated with a task or location may be created in accordance with a workflow of which that task is a part. The back-end application computer server 202 may associate a selected product identifier, workflow 206 and parameters 212 in the workflow datastore 204 with a selected location identifier 234 for a location record 233 in the location rules datastore 216, and the selected release date 406. The location record 233 may also include an agency identifier (ID) 236 identifying the organizational group associated with that location, and one or more location parameters 238.

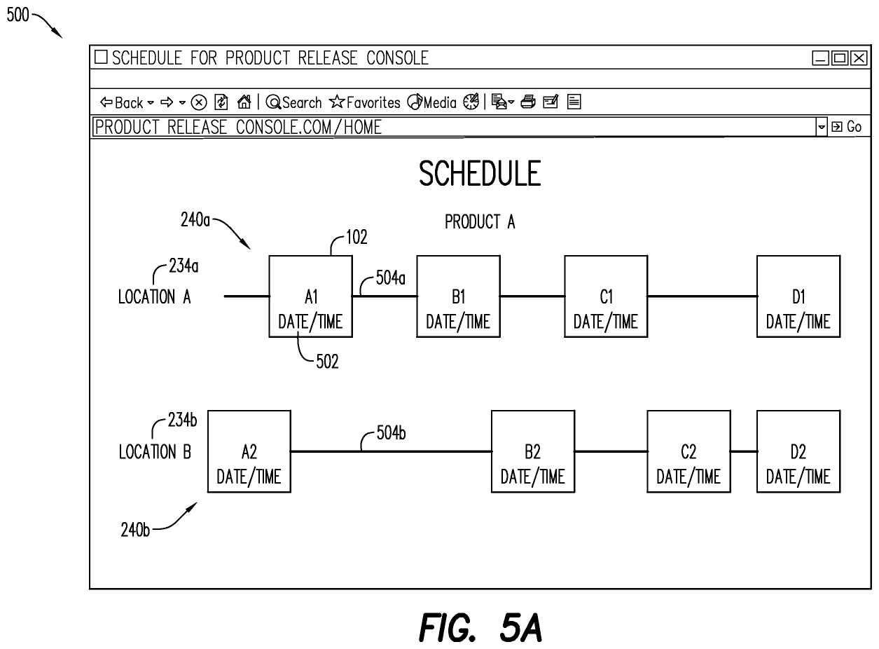

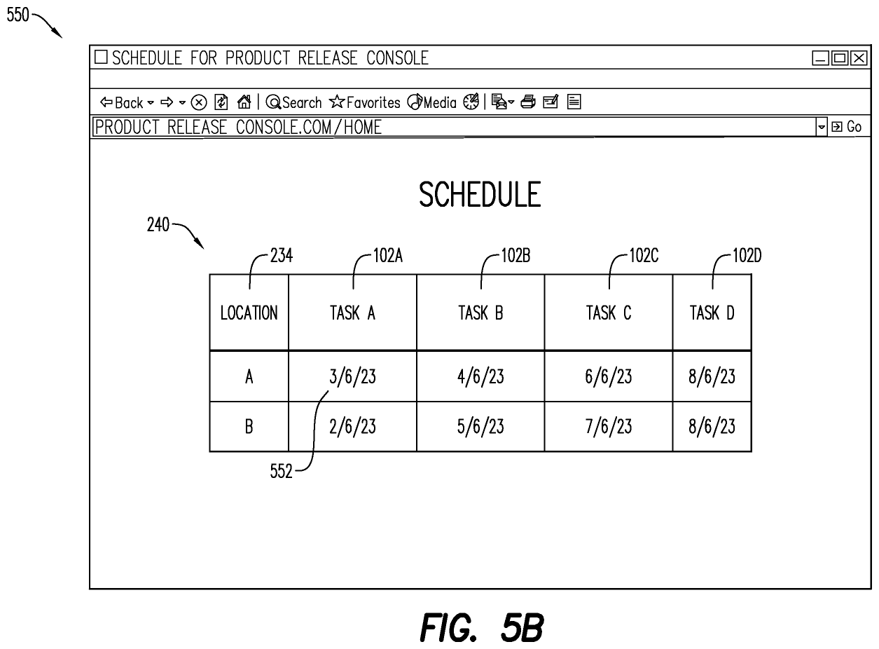

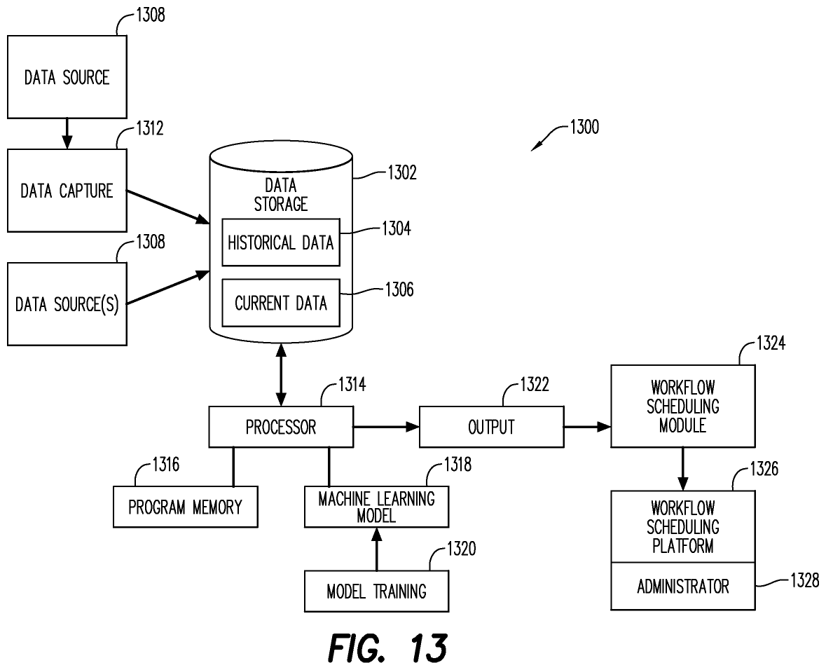

Next, in S314, the retrieved data is input to a scheduler model algorithm (“scheduler”) 220. The scheduler 220 generates a schedule 240 (FIG. 5A) in S316 via the scheduler model algorithm 220 based on the retrieved one or more workflow parameters and one or more location parameters. The scheduler model algorithm 220 may be a machine learning algorithm used to perform automatic scheduling of tasks in a workflow (described in detail with respect to FIG. 13), based in part on the amount of time each task takes to complete. In the non-exhaustive example shown herein, the schedule 240a, 240b is generated for two locations 234a, 234b. The schedule 240 includes a plurality of tasks 102, each having an assigned execution date/time 502. The schedule 240 may be displayed in any suitable format. Herein, the displayed schedule 240 includes the plurality of tasks 102 sequentially positioned along a respective timeline 504a, 504b. For Location A 234a, these are tasks 102 A1, B1, C1 and D1. For Location B 234b, these are tasks A2, B2, C2 and D2. The lines 502a, 502b may be parallel and the tasks 102 arranged on the timelines 504a, 504b such that a user is able to observe, at a glance, the different execution date/time for the tasks at the different locations. As shown herein, both locations A and B have a same release date (e.g., a date on which a product is due to become available for the public to see/buy) for Product A indicated by a same position on the timeline for task D1/D2. While the same tasks are required for the release of Product A at Location A and Location B, the tasks 102 may occur at different points on the timeline, which may be due to workflow parameters 212 and/or location parameters 238, for example, to achieve a same release date. The schedule 240 may be stored in any suitable datastore.

FIG. 5B provides another display 550 of a schedule 240. Herein, the schedule 240 is in a table format with a row for each location 234 and a column for each task 102. While the values 552 shown herein are dates, the values may also include time, entity responsible for executing the task, status, contact information or any other suitable information.

Pursuant to some embodiments, the items in the schedule may be marked (e.g., a particular font, size, bold, underline, italic, etc.) or highlighted to indicate a task status. As a non-exhaustive example, green highlight may indicate a task as approved, while a yellow highlight may indicate an area of concern as the date may have been missed or is expected to be missed, and gray may indicate the task has been completed.

Turning back to the process 300, then in S318, the schedule 240 is imported to a project plan tool 250. A project plan tool 250 may generate a project plan 252, based on the schedule 240, in part. The project plan 252 may be a series of formal documents that define the execution and control stages of a project (e.g., rollout of a product). The project plan 252 may include considerations for risk management, resource management and communications, while also addressing scope, cost and schedule baselines. Pursuant to some embodiments, a project plan may be generated for each location and each product.

Pursuant to some embodiments, a communication port may be coupled to the back-end application computer server to facilitate an exchange of data with the remote user device to support interactive user interface displays that provide information about the schedule.

In one or more embodiments, the back-end application server 202 may use the schedules and other data stored in the datastores 204, 214, 216 to generate report(s) and implement status trackers (e.g., approved—in market; approved—not yet in market; pending DOI; pricing phase; filing prep phase, research phase, etc.).

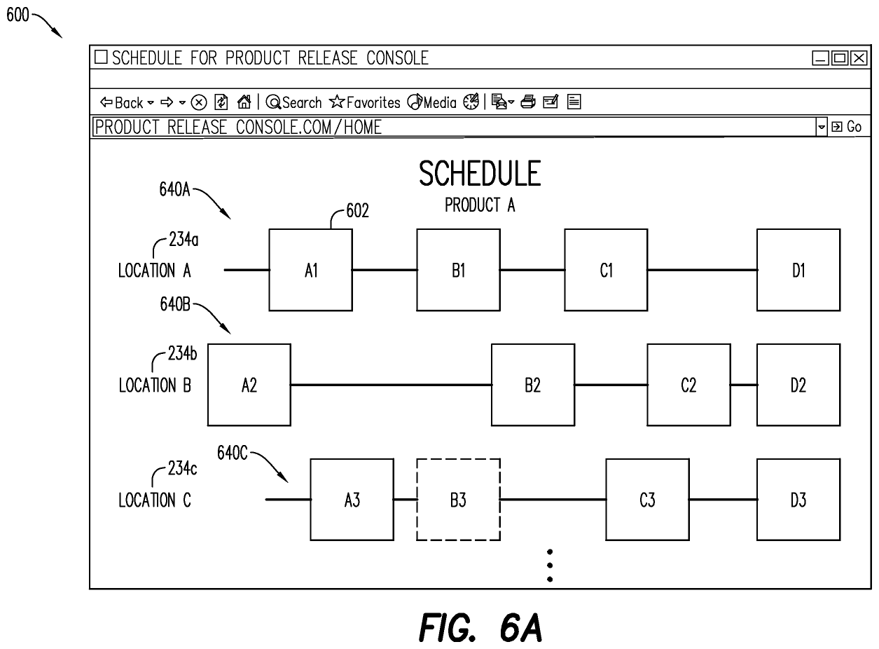

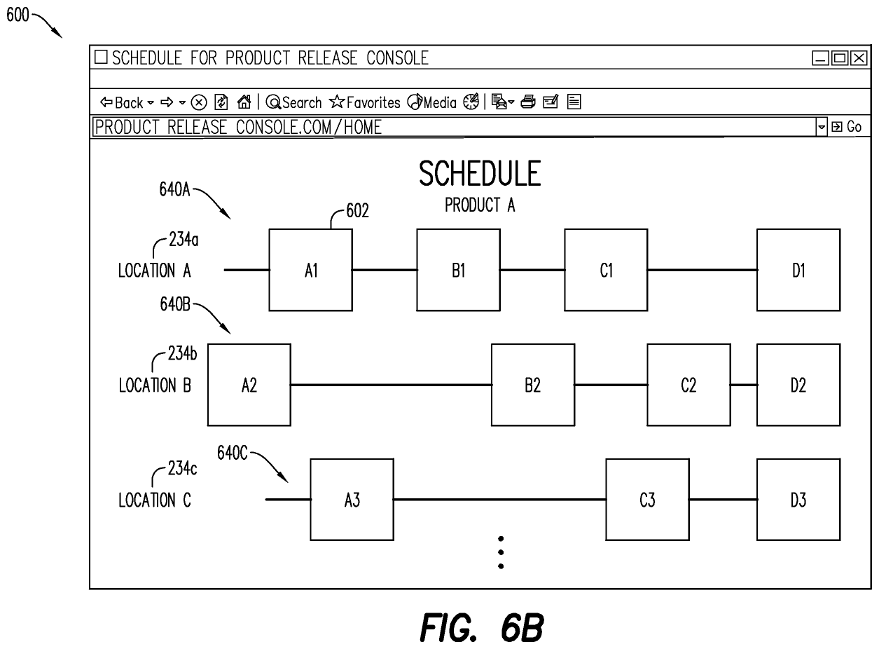

FIGS. 6A and 6B are an example of a schedule display 600 in accordance with some embodiments. The display 600 includes workflow schedules 640A-C for the release of Product A in three locations (Location A, Location B and Location C). Like the schedules displayed in FIG. 5A, the schedules here include a same release date as indicated by D1, D2, and D3 being aligned at a same position on the timeline, and have the other same tasks 602A_{1, 2, 3}, 602B_{1, 2, 3} and 602C_{1, 2, 3} occurring at different times along the timeline for the different locations. In some instances, however, all of the tasks may not be necessary in all of the locations, per the workflow rules and/or location rules. This is shown in FIG. 6A by task B3 for location C having a dotted outline to indicate B3 is not included. Other visual enhancements may be applied to indicate a task is not included (e.g., grayed out, highlighted, etc.). This is shown in FIG. 6B by the removal of task B3 for location C.

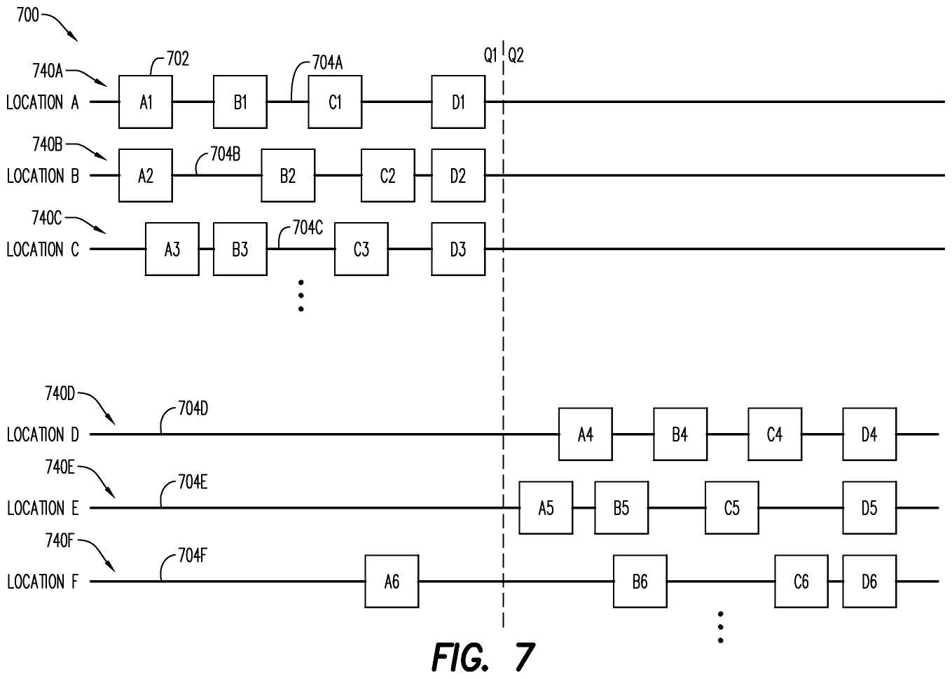

FIG. 7 is another example of a schedule display 700 in accordance with some embodiments. Here, the schedule 740A-F includes staggered release dates in different quarters (Q1 and Q2) for six locations (Location A-F) associated with Product A as indicated by the position of the tasks 702 on their respective timeline 704A-E.

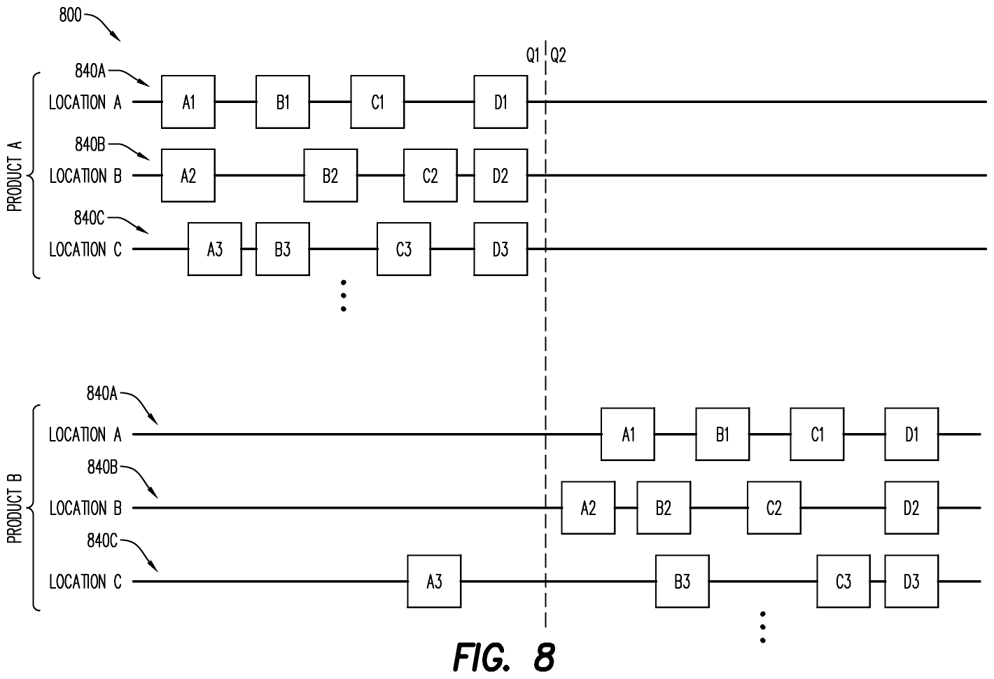

FIG. 8 is yet another example of a schedule display 800 in accordance with some embodiments. Here, the schedule 840A-C includes staggered release dates in different quarters (Q1 and Q2) for different products (Product A and Product B), with the release dates (D) for Product A occurring in Q1 and the release date (D) for Product B occurring in Q2. It is noted that task A3 for schedule 840C for Product B is scheduled for Q1, while the remaining tasks are scheduled for Q2.

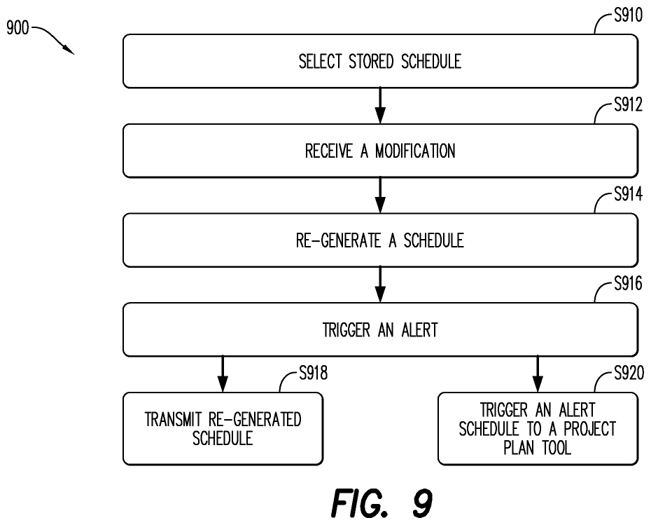

Turning to FIG. 9, a process 900 of re-generating a schedule in accordance with some embodiments is provided. Prior to the start of the process 900, a schedule was generated, for example via the process 300 described above, and saved in a data store.

Initially, at S910 a stored schedule 240 is selected. Then at S912 a modification for at least one task 102 in the workflow 100 is received at the scheduler 220. The modification may be an event that may impact the schedule. Non-exhaustive examples include, a delay in performance of a task, the addition of a new task, the removal of a task, etc. For example, the review of the product plan with a regulatory agency is delayed, state rules change, two tasks have become streamlined into one task, etc. The modification may be received from a user device or other suitable system.

The scheduler 220 then re-generates a schedule 240 (“re-generated schedule”) in S914 via the scheduler model algorithm 220 based on the modifications and the one or more workflow parameters and one or more location parameters. In some embodiments, the re-generated schedule may include all of the tasks for the workflow, including those already completed, while in other embodiments, the re-generated schedule may include only those tasks that have not yet been completed for the workflow. According to some embodiments, the re-generation of a schedule may trigger an alert in S916 to at least one of the remote user device 222 and any downstream system e.g., via communication link 226. The alert may indicate a change in the schedule. With respect to the other system, this system may need to alter its processes based on this change. For example, if the other system prepares release materials, the other system may change the date on which they prepare the release materials. As another non-exhaustive example, the other system may need to reallocate resources based on the re-generated schedule. In S918, the re-generated schedule may be transmitted to another system. At a same time, S920, the re-generated schedule is imported to the project plan tool 250.

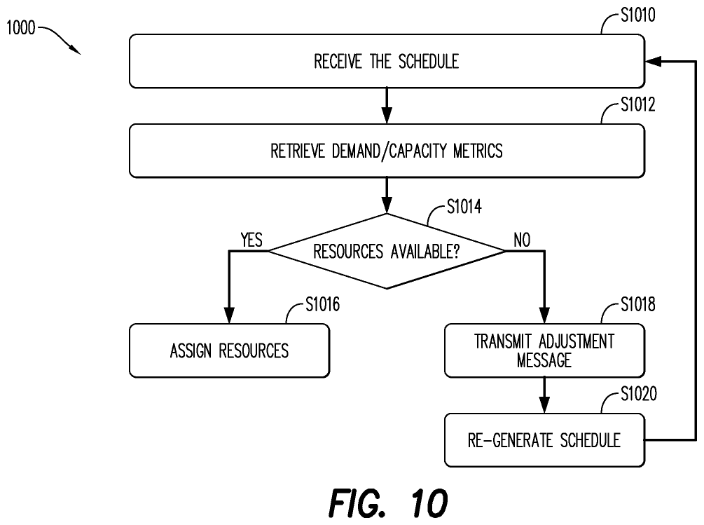

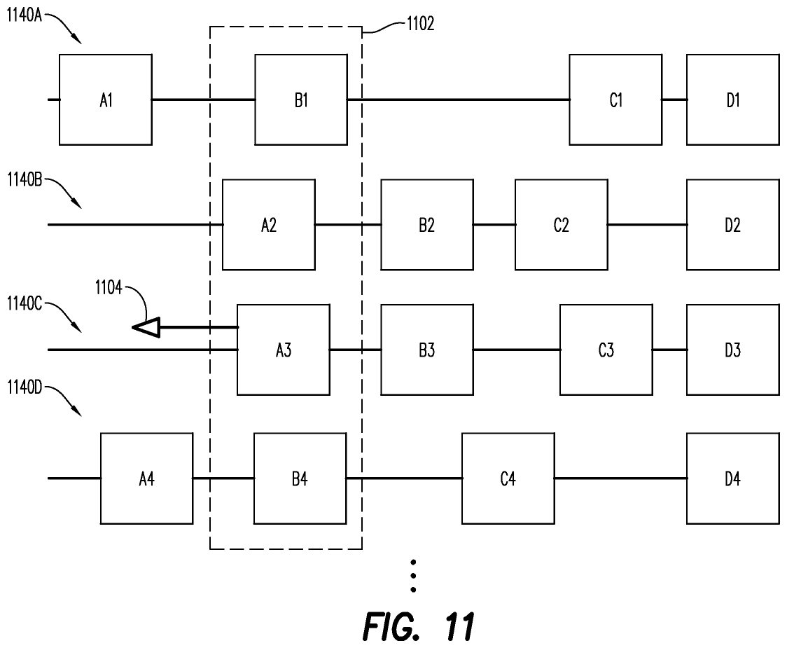

Turning to FIGS. 10 and 11, a process 1000 of identifying resources for execution of the schedule is provided in accordance with some embodiments. Prior to the start of the process 900, a schedule was generated, for example via the process 300 described above, and saved in a data store.

Initially at S1010, a resource management tool 260 receives the schedule. Then, at S1012 the resource management tool 260 retrieves demand/capacity metrics for one or more resources. The demands may be, as a non-exhaustive example, hours devoted to development time and filings, as well as downtime. The capacity may be the available resources less the demand. At S1014, the resource management tool 260 executes a capacity algorithm 262 to determine the availability of resources to execute the tasks in the workflow per the schedule.

In a case it is determined at S1014 that resources are available for each task, the resource management tool assigns resources to execute the tasks in the workflow per the schedule at S1016.

In a case it is determined at S1014 that resources are not available for each task, the resource management tool may send a message to the scheduler 220 in S1018 indicating the schedule should be adjusted. The message may also include the constraints causing the need for adjustment (e.g., Resource A is unavailable to complete task B at the scheduled time). Then in S1020, the scheduler re-generates a schedule (“re-generated schedule”) via the scheduler model algorithm 220 based on the constraints included in the message and the one or more workflow parameters and one or more location parameters. The re-generated schedule may be stored in any suitable datastore. Next, the process 1000 returns to S1010 and the re-generated schedule is returned to the resource management tool 260.

For example, FIG. 11 shows a schedule 1140A-D for releasing Product A in four locations at a same time (D). As indicated herein, different tasks for workflows for different locations may occur at a same, or approximately same time. For example, B1, A2, A3 and B4 may occur at approximately the same time, as indicated by the dotted box 1102 around them. In this non-exhaustive example, is determined at S1014 that there are not enough resources available to perform tasks B1, A2, A3 and B4. The scheduler then receives a message indicating the schedule should be adjusted due to lack of resources at the given time. The scheduler then re-generates a schedule (“re-generated schedule”) via the scheduler model algorithm 220 based on the constraints included in the message and the one or more workflow parameters and one or more location parameters. In this example, the scheduler determined that A3 may be shifted to an earlier time, indicated by the arrow 1104, to address the resource constraint and maintain completion of the workflow by the pre-set time D1-D4.

The embodiments described herein may be implemented using any number of different hardware configurations. For example, FIG. 12 illustrates an apparatus 1200 that may be, for example, associated with the system 200 described with respect to FIG. 2. The apparatus 1200 comprises a processor 1210, such as one or more commercially available Central Processing Units (“CPUs”) in the form of one-chip microprocessors, coupled to a communication device 1220 configured to communicate via a communication network (not shown in FIG. 12). The communication device 1220 may be used to communicate, for example, with one or more remote third-party business or economic platforms, administrator computers, insurance agent, and/or communication devices (e.g., PCs and smartphones). Note that communications exchanged via the communication device 1220 may utilize security features, such as those between a public internet user and an internal network of an insurance company and/or an enterprise. The security features might be associated with, for example, web servers, firewalls, and/or PCI infrastructure. The apparatus 1200 further includes an input device 1240 (e.g., a mouse and/or keyboard to enter information about data sources, research data, state data, release dates, etc.) and an output device 1250 (e.g., to output reports regarding schedules, status, alerts, etc.).

The processor 1210 also communicates with a storage device 1230. The storage device 1230 may comprise any appropriate information storage device, including combinations of magnetic storage devices (e.g., a hard disk drive), optical storage devices, mobile telephones, and/or semiconductor memory devices. The storage device 1230 stores a program 1215 and/or an application for controlling the processor 1210. The processor 1210 performs instructions of the program 1215, and thereby operates in accordance with any of the embodiments described herein. For example, the processor 1210 may receive a release date, and retrieve state rules and workflow parameters. The processor 1210 may then automatically generate a schedule of execution of tasks in a workflow based on the received data.

The program 1215 may be stored in a compressed, uncompiled and/or encrypted format. The program 1215 may furthermore include other program elements, such as an operating system, a database management system, and/or device drivers used by the processor 1210 to interface with peripheral devices.

As used herein, information may be “received” by or “transmitted” to, for example: (i) the apparatus 1200 from another device; or (ii) a software application or module within the apparatus 1200 from another software application, module, or any other source.

In some embodiments (such as shown in FIG. 12), the storage device 1230 further includes a workflow data store 1270, a risk relationship data store 1280 and a location rules data store 1290.

According to some embodiments, one or more machine learning algorithms and/or predictive models may be used to perform automatic schedule generation, and re-generation. Features of some embodiments associated with a model will now be described by referring to FIG. 13. FIG. 13 is a partially functional block diagram that illustrates aspects of a computer system 1300 provided in accordance with some embodiments of the invention. For present purposes it will be assumed that the computer system 1300 is operated by an insurance company (not separately shown) for the purpose of supporting automated schedule generation for a product release (e.g., to streamline and manage tasks in a workflow for the product release). According to some embodiments, the third-party data and/or risk relationship data may also be used to supplement and leverage the computer system 1300.

The computer system 1300 includes a data storage module 1302. In terms of its hardware the data storage module 1302 may be conventional, and may be composed, for example, by one or more magnetic hard disk drives. A function performed by the data storage module 1302 in the computer system 1300 is to receive, store and provide access to both historical data 1304 and current data 1306. As described in more detail below, the historical data 1304 is employed to train a machine learning model to provide an output that indicates an identified performance metric and/or an algorithm to generate a schedule for a workflow, and the current data 1306 is thereafter analyzed by the model. Moreover, as time goes by, and results become known from processing current workflow schedules, at least some of the current decisions may be used to perform further training of the model. Consequently, the model may thereby adapt itself to changing conditions.

Either the historical data 1304 and/or the current data 1306 may include, according to some embodiments, location rule data, product/workflow data etc. The data may come from one or more data sources 1308 that are included in the computer system 1300 and are coupled to the data storage module 1302. Non-exhaustive examples of data sources may be the insurance company's policy database (not separately indicated), state DOI databases, etc. It is noted that the data may originate from data sources whereby the data may be extracted from raw files or the like by one or more data capture modules 1312. The data capture module(s) 1312 may be included in the computer system 1300 and coupled directly or indirectly to the data storage module 1302. Examples of the data source(s) 1308 that may be captured by a data capture model 1312 include data storage facilities for big data streams, document images, text files, and web pages (e.g., DOI webpages). Examples of the data capture module(s) 1312 may include one or more optical character readers, a speech recognition device (i.e., speech-to-text conversion), a computer or computers programmed to perform NLP, a computer or computers programmed to identify and extract information from images or video, a computer or computers programmed to detect key words in text files, and a computer or computers programmed to detect indeterminate data regarding an employee such as a questionnaire response, etc.

The computer system 1300 also may include a computer processor 1314. The computer processor 1314 may include one or more conventional microprocessors and may operate to execute programmed instructions to provide functionality as described herein. Among other functions, the computer processor 1314 may store and retrieve historical insurance data and schedules 1304 and current data 1306 in and from the data storage module 1302. Thus, the computer processor 1314 may be coupled to the data storage module 1302.

The computer system 1300 may further include a program memory 1316 that is coupled to the computer processor 1314. The program memory 1316 may include one or more fixed storage devices, such as one or more hard disk drives, and one or more volatile storage devices, such as RAM devices. The program memory 1316 may be at least partially integrated with the data storage module 1302. The program memory 1316 may store one or more application programs, an operating system, device drivers, etc., all of which may contain program instruction steps for execution by the computer processor 1314.

The computer system 1300 further includes a machine learning model component 1318. In certain practical embodiments of the computer system 1300, the machine learning model component 1318 may effectively be implemented via the computer processor 1314, one or more application programs stored in the program memory 1316, and computer stored as a result of training operations based on the historical data 1304 (and possibly also data received from a third party). In some embodiments, data arising from model training may be stored in the data storage module 1302, or in a separate computer store (not separately shown). A function of the machine learning model component 1318 may be to generate a schedule for tasks in a workflow, etc. The machine learning model component may be directly or indirectly coupled to the data storage module 1302.

The machine learning model component 1318 may operate generally in accordance with conventional principles for machine learning models, except, as noted herein, for at least some of the types of data to which the machine learning model component is applied. Those who are skilled in the art are generally familiar with programming of predictive/machine learning models. It is within the abilities of those who are skilled in the art, if guided by the teachings of this disclosure, to program a predictive/machine learning model to operate as described herein.

Still further, the computer system 1300 includes a model training component 1320. The model training component 1320 may be coupled to the computer processor 1314 (directly or indirectly) and may have the function of training the machine learning model component 1318 based on the historical data 1304 and/or information about entities. (As will be understood from previous discussion, the model training component 1320 may further train the machine learning model component 1318 as further relevant data becomes available.) The model training component 1320 may be embodied at least in part by the computer processor 1314 and one or more application programs stored in the program memory 1316. Thus, the training of the machine learning model component 1318 by the model training component 1320 may occur in accordance with program instructions stored in the program memory 1316 and executed by the computer processor 1314.

In addition, the computer system 1300 may include an output device 1322. The output device 1322 may be coupled to the computer processor 1314. A function of the output device 1322 may be to provide an output that is indicative of (as determined by the trained machine learning model component 1318) particular task schedules for a workflow, etc. The output may be generated by the computer processor 1314 in accordance with program instructions stored in the program memory 1316 and executed by the computer processor 1314. More specifically, the output may be generated by the computer processor 1314 in response to applying the data for the current simulation to the trained machine learning model component 1318. The output may, for example, be a defined sequence of tasks to be completed by particular date/times, automatically generated alerts, etc. In some embodiments, the output device may be implemented by a suitable program or program module executed by the computer processor 1314 in response to operation of the machine learning model component 1318.

Still further, the computer system 1300 may include a workflow scheduling module 1324. The workflow scheduling module 1324 may be implemented in some embodiments by a software module executed by the computer processor 1314. The workflow scheduling module 1324 may have the function of rendering a portion of the display on the output device 1322. Thus, workflow scheduling module 1324 may be coupled, at least functionally, to the output device 1322. In some embodiments, for example, the workflow scheduling module 1324 may direct communications with an enterprise by referring to an administrator/project leader 1328 via a workflow scheduling platform 1326, messages customized and/or generated by the machine learning model component 1318 (e.g., suggesting schedules for tasks in a workflow, alerts or appropriate actions, re-generating schedules etc.) and found to be associated with various parties or types of parties.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A system implemented via a back-end application computer server of an enterprise, comprising:
(a) a workflow data store containing a plurality of workflows, each workflow including a plurality of executable tasks;
(b) the back-end application computer server, coupled to the workflow data store, including:
a computer processor;
a computer memory coupled to the computer processor and storing instructions that, when executed by the computer processor, cause the back-end application computer server to:
receive a request to generate a schedule for execution of a workflow associated with at least one product;
retrieve one or more workflow parameters and one or more location parameters;
input the retrieved one or more workflow parameters and one or more location parameters into a scheduler;
automatically generate a workflow schedule via the scheduler based on the retrieved one or more workflow parameters and location parameters;
import the generated workflow schedule to a project plan; and
(c) a communication port coupled to the back-end application computer server to facilitate an exchange of data with a remote device to support interactive user interface displays that provide information about the schedule.

2. The system of claim 1, wherein the workflow schedule includes a date of execution for each task.

3. The system of claim 1, wherein the request includes a release date associated with the at least one product.

4. The system of claim 3, wherein the one or more location parameters are linked to a location and define one or more location-specific rules, and a date of execution for at least one task is based on the one or more location-specific rules.

5. The system of claim 1, wherein the executable task is at least one of: researching regulations, defining requirements, executing a pricing engine, and filing the product with an approval organization.

6. The system of claim 1, wherein the workflow is associated with one of: an update of the product and an extension of the product.

7. The system of claim 1, wherein the product is at least one of an automobile product and a home product.

8. The system of claim 4, wherein the location is at least one state of the United States of America.

9. The system of claim 1, further comprising instructions that cause the back-end computer server to:
receive a modification to a first task in the workflow of the request;
re-generate the workflow schedule in response to the received modification; and
import the re-generated workflow schedule to the project plan.

10. The system of claim 1, further comprising instructions that cause the back-end application computer to:
transmit the project plan to a resource management tool; and
identify, via the resource management tool, one or more resources adapted to execute the workflow schedule.

11. A method implemented via a back-end application computer server of an enterprise, comprising:
receiving a request to generate a schedule for execution of a workflow associated with at least one product;
retrieving one or more workflow parameters and one or more location parameters;
inputting the retrieved one or more workflow parameters and one or more location parameters into a scheduler;
automatically generating a workflow schedule via the scheduler based on the retrieved one or more workflow parameters one or more location parameters, wherein the workflow schedule includes a date of execution for each task; and
importing the generated workflow schedule to a project plan.

12. The method of claim 11, wherein the request includes a release date associated with at least one product.

13. The method of claim 12, wherein the one or more location parameters are linked to a location and define one or more location-specific rules, and a date of execution for at least one task is based on the one or more location-specific rules.

14. The method of claim 11, wherein the executable task is at least one of: researching regulations, defining requirements, executing a pricing engine, and filing the product with an approval organization.

15. The method of claim 11, wherein the workflow is associated with one of: an update of the product and an extension of the product.

16. The method of claim 11, wherein the product is at least one of an automobile product and a home product.

17. The method of claim 11, further comprising:
receiving a modification to a first task in the workflow of the request;
re-generating the workflow schedule in response to the received modification; and
importing the re-generated workflow schedule to the project plan.

18. The method of claim 11, further comprising:
transmitting the project plan to a resource management tool; and
identifying, via the resource management tool, one or more resources adapted to execute the workflow schedule.

19. A non-transitory, computer-readable medium storing instructions that, when executed by a processor, cause the processor to perform a method implemented via a back-end application computer server of an enterprise, the method comprising:
receiving a request to generate a schedule for execution of a workflow associated with at least one product;
retrieving one or more workflow parameters and one or more location parameters;
inputting the retrieved one or more workflow parameters and the one or more location parameters into a scheduler;
automatically generating a workflow schedule via the scheduler based on the retrieved one or more workflow parameters and one or more location parameters, wherein the workflow schedule includes a date of execution for each task; and
importing the generated workflow schedule to a project plan.

20. The medium of claim 19, wherein the one or more location parameters are linked to a location and define one or more location-specific rules, and a date of execution for at least one task is based on the one or more location-specific rules.
